(19) United States
(12) Patent Application Publication
(10) Pub. No.: US 2007/0044485 A1
(43) Pub. Date: Mar. 1, 2007

(54) Liquid Natural Gas Vaporization Using Warm and Low Temperature Ambient Air

(76) Inventor: George Mahl, Harahan, LA (US)

Correspondence Address: GARVEY SMITH NEHRBASS & NORTH, LLC, LAKEWAY 3, SUITE 3290, 3838 NORTH CAUSEWAY BLVD., METAIRIE, LA, 70002, US

(21) Appl. No.: 11/419,869

(22) Filed: May 23, 2006

Related U.S. Application Data
(60) Provisional application No. 60/711,879, filed on Aug. 26, 2005.

(51) Int. Cl. F17C 9/02

(52) U.S. Cl. 62/50.2

(57) ABSTRACT

A heat transfer fluid can be circulated through an LNG vaporizer, then to a liquid-to-air heat exchanger. Ambient air can be introduced into liquid-to-air heat exchanger to warm the heat transfer fluid while a pump circulates the heat transfer fluid back through the LNG vaporizer. An option is provided for a supplemental heat transfer fluid used to additionally heat LNG or gasified LNG to an appropriate outlet temperature.

### CROSS-REFERENCE TO RELATED APPLICATIONS

Priority of U.S. Provisional Patent Application Ser. No. 60/711,879, filed Aug. 26, 2005, incorporated herein by reference, is hereby claimed.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND

Liquified natural gas (LNG) is normally transported overseas as a cryogenic liquid in specialized vessels. At the receiving terminal this cryogenic liquid, which is approximately at atmospheric pressure and at a temperature of around −260 degrees F., must be gasified and fed to a distribution system at ambient temperature and at a suitably elevated pressure, typically ranging up to 80 atmospheres. In many installations the LNG is pumped to the required pressure so that when heat is added and it is gasified, no compression of the resultant natural gas is required.

In many installations LNG is simply heated with a large flow of ambient sea water which large flow is required to avoid ice formation. One disadvantage of using ambient sea water is the at least localized decrease in temperature of the sea water which can adversely impact the localized environment (e.g., kill marine life). In many cases because of the adverse impacts on the environment, the use of ambient sea water is banned for gasifying LNG.

In some instances heat is added to LNG by burning a fuel. In the instance of heat being produced by burning fuel, the cost of the fuel is a significant expense of the operation.

In some instances, for low flow rates of LNG, ambient air has been used as a source of heat for LNG for gasification. However, where the tubes containing LNG are in contact with the ambient air, ice buildup on the vaporizers impedes the transfer of heat, and frequent defrosting of the vaporizers are required. This defrosting becomes burdensome when these vaporizers are utilized in high humidity climates. In some instances, ambient air may be utilized for vaporizing LNG by circulating water through the LNG vaporizer, then warming the water in an air/water direct heat exchanger similar to a cooling tower. However, that method is limited to a minimum air temperature of 50 degrees Fahrenheit to 60 degrees Fahrenheit. At lower temperatures, the water freezes when it enters the LNG vaporizer.

While certain novel features of one or more embodiments shown and described below are pointed out in the annexed claims, the invention is not intended to be limited to the details specified, since a person of ordinary skill in the relevant art will understand that various omissions, modifications, substitutions and changes in the forms and details of the one or more embodiments illustrated and in their operation may be made without departing in any way from the spirit of the present invention. No feature of the invention is critical or essential unless it is expressly stated as being “critical” or “essential.”

### BRIEF SUMMARY

In one embodiment heat energy contained in ambient air is transferred to liquified natural gas (LNG) to vaporize the LNG into a gaseous form, even where the ambient temperature is below zero degrees C.

In one embodiment, a heat transfer fluid can be circulated through an LNG vaporizer, then to a liquid-to-air heat exchanger. Ambient air can be introduced into the liquid-to-air heat exchanger to warm the heat transfer fluid while a pump circulates the heat transfer fluid back through the LNG vaporizer.

In one embodiment a supplement heat transfer fluid can be use to additionally heat the LNG or gasified LNG to an appropriate outlet temperature and pressure.

The drawings constitute a part of this specification and include exemplary embodiments to the invention, which may be embodied in various forms.

### BRIEF DESCRIPTION OF THE SEVERAL VIEWS OF THE DRAWINGS

For a further understanding of the nature, objects, and advantages of the present invention, reference should be had to the following detailed description, read in conjunction with the following drawings, wherein like reference numerals denote like elements and wherein:

FIG. 1 schematic diagram illustrating one embodiment;

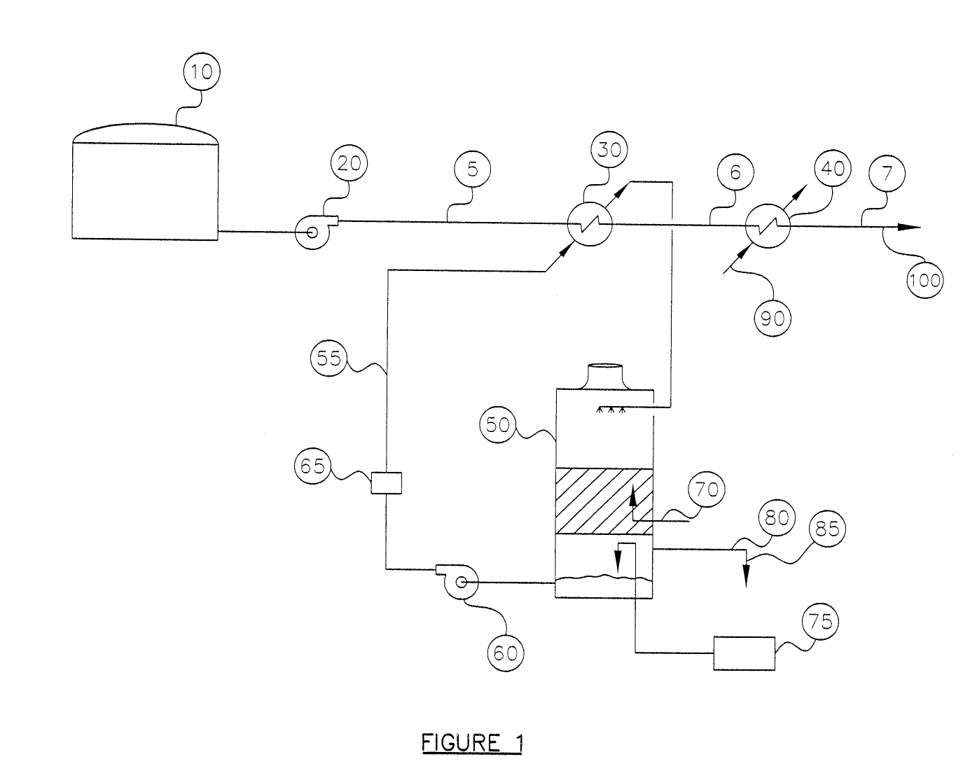

### DETAILED DESCRIPTION

Detailed descriptions of one or more preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in any appropriate system, structure or manner.

In one embodiment heat energy contained in ambient air is transferred to liquified natural gas (LNG) to vaporize the LNG into a gaseous form.

In one embodiment, a heat transfer fluid 55 is circulated through LNG vaporizer 30, then to a liquid-to-air heat exchanger 50 (which may be a direct contact exchanger such as a cooling tower, or may be a unit in which the liquid is contained in tubes or plates). Air 70 can be introduced into liquid-to-air heat exchanger 50 to warm heat transfer fluid 55 while pump 60 circulates heat transfer fluid 55 back through LNG vaporizer 30.

LNG pump 20, pumps LNG 5 from storage tank 10 to LNG vaporizer 30, where LNG 5 is vaporized by heat from heat transfer fluid 55. Natural gas 6, as a vapor, then exits LNG vaporizer 30 and enters supplemental heater 40 (e.g., trim heater) where it can be warmed further to an appropriate discharge temperature 7 and is discharged to the transportation pipeline by outlet piping 100.

In one embodiment heat transfer fluid 55 can be Calcium Chloride Brine, Sodium Chloride Brine, and Aqueous Solution of Ethylene Glycol, an Aqueous Solution of Propylene Glycol, or other fluid having a sufficiently low freezing point.

In one embodiment, water will condense in the liquid/air heat exchanger 50 when heat transfer fluid 55 is warmed by air 70 (such as from humidity in air 70). This condensation process can create an excess of heat transfer fluid 55 which excess can be discharged from the process through outflow 80. The excess fluid outlet 85 may be attached to the collecting basin at the bottom of liquid/air heat exchanger 50, or may be attached to suitable sump or overflow located anywhere in air heat supply process 52.

In one embodiment, the excess liquid discharged through excess fluid outlet 85 may require treatment prior to disposal. When brines are used as the heat transfer fluid, the excess brine water can be evaporated, and the salts recovered and reintroduced into the heat transfer fluid to maintain the desired concentration. When glycol solutions are used as heat transfer fluid 55, the glycol can be separated from the water in a glycol reboiler, recovered and reintroduced into heat transfer fluid 55. When environmental regulations permit, the excess liquid discharged through excess fluid outlet 85 may be discharged into the environment without treatment.

In one embodiment, a second heat transfer fluid 90 can supply additional heat gasified LNG 6 through trim heater 40. This second heat transfer fluid 90 can be at a sufficient temperature to warm the gasified LNG to an appropriate discharge temperature for discharge in outlet 100. In one embodiment this second heat transfer fluid 90 may be a stream off liquid/air heat exchanger 50 in those instances where ambient air 70 temperature is sufficiently warm to heat gasified LNG to an appropriate outlet temperature. When ambient air 70 temperature is not sufficiently warm to supply heat to second heat transfer fluid and thereby raise the temperature of the gasified LNG to a required exit temperature, then other means can be employed to provide sufficient heat to trim heater 40. Another means of providing heat to raise the temperature of secondary heat transfer fluid 90 is to use steam from a boiler as fluid 90, or to heat secondary heat transfer fluid 90 in a fired heater, or to heat secondary heat transfer fluid 90 in a waste heat recovery unit on a gas turbine.

Analyzer 65 can be used to analyze the constituency of heat transfer fluid 55. When required make up feed unit 75 can be used to maintain the proper chemical balance of heat transfer fluid 55. For example, where sodium chloride brine is used for heat transfer fluid 55, over time humidity in the ambient air will precipitate out (while in liquid-to-air heat exchanger 50) adding water to heat transfer fluid 55 and thereby diluting the brine content of heat transfer fluid 55. When analyzer 65 detects that the constituency of the brine content is too low make up feed unit 75 can be used to increase the brine content of heat transfer fluid 55 back up to an acceptable level.

The cooling of ambient air 70 is not expected to have harmful effects to the environment (unlike use of ambient sea water).

The following is a list of reference numerals:

LIST FOR REFERENCE NUMERALS

| (Reference No.) | (Description) |
|---|---|
| 5 | LNG |
| 6 | natural gas |
| 7 | discharge temperature |
| 10 | storage tank |
| 20 | pump |
| 30 | LNG vaporizer |
| 40 | supplemental heater |
| 50 | liquid-to-air heat exchanger |
| 52 | air heat supply process |
| 55 | heat transfer fluid |
| 60 | pump |
| 65 | analyzer |
| 70 | air |
| 75 | make up feed unit |
| 80 | outflow |
| 85 | excess fluid outlet |
| 90 | second heat transfer fluid |
| 100 | outlet |

All measurements disclosed herein are at standard temperature and pressure, at sea level on Earth, unless indicated otherwise. All materials used or intended to be used in a human being are biocompatible, unless indicated otherwise.

It will be understood that each of the elements described above, or two or more together may also find a useful application in other types of methods differing from the type described above. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention set forth in the appended claims. The foregoing embodiments are presented by way of example only; the scope of the present invention is to be limited only by the following claims.

1. A method of gasifying liquified natural gas comprising:
(a) providing a source of LNG;
(b) providing a source of ambient air;
(c) providing a liquid to air heat exchanger;
(d) providing a first heat transfer fluid with a freezing point below about minus five degrees F.;
(e) using the ambient air to warm the first heat exchange fluid by passing ambient air and the first heat transfer fluid to through the liquid to air heat exchanger;
(f) using the warmed first heat exchange fluid to vaporize LNG from the source of LNG.

2. The method of claim 1, further including the step of providing a second heat transfer fluid and, using the second heat transfer fluid to warm the LNG vaporized in step “f”.

3. The method of claim 1, wherein the first heat transfer fluid is selected from the group consisting of Calcium Chloride Brine, Sodium Chloride Brine, Aqueous Solution of Ethylene Glycol, and Aqueous Solution of Propylene Glycol.

4. The method of claim 1, wherein the first heat transfer fluid is Calcium Chloride Brine.

5. The method of claim 1, wherein the first heat transfer fluid is Sodium Chloride Brine.

6. The method of claim 1, wherein the first heat transfer fluid includes Ethylene Glycol.

7. The method of claim 1, wherein the first heat transfer fluid includes Propylene Glycol.

8. The method of claim 1, including the further steps of providing a makeup feed unit, providing an analyzer, the analyzer measuring the constituency of the first heat transfer fluid for meeting a first predetermined level, and using the makeup feed unit to correct the constituency of the first heat transfer fluid when the constituency does not meet the first predetermined level.

9. The invention substantially as shown and described herein.
